(19) United States
(12) Patent Application Publication
(10) Pub. No.: US 2004/0177003 A1
(43) Pub. Date: Sep. 9, 2004

(54) Adaptive electronic coupon

(75) Inventors: Paul Liao, Fairhaven, NJ (US); Tony Jasionowski, Haworth, NJ (US); Eran Sitnik, Ossining, NY (US); Charles S. Hare, Whippany, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC COMPANY OF AMERICA, Secaucus, NJ

(21) Appl. No.: 10/800,480

(22) Filed: Mar. 15, 2004

Related U.S. Application Data
(63) Continuation of application No. PCT/US02/29777, filed on Sep. 19, 2002.
(60) Provisional application No. 60/323,222, filed on Sep. 19, 2001.
(60) Provisional application No. 60/323,356, filed on Sep. 19, 2001.

(51) Int. Cl. G06F 17/60

(52) U.S. Cl. 705/14

(57) ABSTRACT

A system for conditionally redeeming an electronic coupon includes a distribution module distributing the adaptive electronic coupon (14) to a user. Electronic coupon metadata automatically changes redemption characteristics of the coupon based on predetermined conditions relating to personal data (24) of the user and a redemption environment (26). A redemption system honors the adaptive electronic coupon at a time and place of redemption based on the predetermined conditions relating to the personal data (24) of the user and the redemption environment (26).

### CROSS-REFERENCE TO RELATED APPLICATIONS

This application is a continuation of International Application No. PCT/US02/29777, filed on Sep. 19, 2002. This application claims the benefit of U.S. Provisional Application No. 60/323,222, filed on Sep. 19, 2001. This application further claims the benefit of U.S. Provisional Application No. 60/323,356, filed on Sep. 19, 2001. The disclosures of the above applications are incorporated herein by reference.

### FIELD OF THE INVENTION

The present invention generally relates to interactive media, and particularly relates to electronic coupons.

### BACKGROUND OF THE INVENTION

Electronic coupons typically provide a specific benefit relative to a specific product, and fail to be adaptive for a particular user and/or redemption environment. The need remains, therefore, for an adaptive electronic coupon that changes redemption characteristics for different users under different circumstances. The present invention provides such a solution.

### SUMMARY OF THE INVENTION

A system for conditionally redeeming an electronic coupon includes a distribution module distributing an adaptive electronic coupon to a user. Electronic coupon metadata automatically changes redemption characteristics of the coupon based on predetermined conditions relating to personal data of the user and a redemption environment. A redemption system honors the adaptive electronic coupon at a time and place of redemption based on the predetermined conditions relating to the personal data of the user and the redemption environment.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram depicting adaptive electronic distribution according to the present invention;

FIG. 2 is a block diagram depicting adaptive electronic coupon redemption according to the present invention; and

FIG. 3 is a flow chart depicting a method of conditionally redeeming an adaptive electronic coupon according to the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention relates generally to hand-held devices and remote control devices. More particularly, the invention relates to a new hand-held, remote control device for interactive operation of consumer electronic products and the like. The various embodiments include capability to interact with the user: to synchronize with audio/video equipment, to synchronize channel changes between television receiver and video recorder, to integrate with set top box in providing interactive TV capabilities using dial memory and two levels of communication, to provide TV show reminders and to improve viewer attention by discouraging channel changing and/or skipping commercials.

In accordance with the presently preferred embodiment, the hand-held device, or remote control can be configured as a universal remote control for controlling television receivers, audio/video equipment, set top boxes, interactive entertainment systems, and the like. The device includes an embedded display, CPU, software memory (volatile, non-volatile and removable) and two way communication, enabling Interactive TV applications, such as gaming, coupon receiving, enhanced information (program related or not). To encourage the user to stay tuned to the same channel throughout a program, the remote control device deploys one or more techniques to detect if viewer break away form the show and react upon such behavior.

The hand-held device in accordance with the invention fulfills at least the following functions:

A. Detecting channel switching, or viewer leaving the room during commercials, or

ignoring the TV.

B. Rewarding the viewer continuously matching TV shows, throughout commercials.

Detecting Viewing Discontinuation:

Encoded “station ID”+“Program ID” code signals are sent from TV (STB) to hand-held device every 15 seconds. The signals are transmitted during the show and during commercials. The signals during commercials and during the show are identical, to prevent commercial detectors. If the hand-held device does not receive the signal for a short while [loss 2-3 signals], it determines that the view selected a different channel and resets the entitlement.

Alternately: the viewer is prompted, during commercials, to press a button on the remote, either answer a simple question, or simply push a button within a time limit. Without user response, the device resets the entitlement.

Alternately: the hand-held device must be touched at least once every predetermined time laps (e.g. 2 minutes). If the device is not touched beyond a time threshold, it resets the entitlement. Optionally, the hand-held device provide and audio and/or visual reminder to be touched.

Rewarding the Viewer:

Entitlement Code: During a game show, the viewer collects points. When enough points are earned, a unique entitlement code appears on the remote control screen. Using the entitlement code, the viewer can contact the publisher to claim a prize. Communication with the publisher is via real-time back channel modem (i.e. cable or dial-up modem), cell phone (SMS message), two-way pager, telephone (oral), Internet (automatically or maually), post mail; etc. Each entitlement code is unique to the remote control device, calculated with the Device's ID number (key). This is to prevent sharing of entitlement code between viewers. Each code is entitled to one prize. Earning the entitlement code does not require active interactivity with a show. Points can be earned by passively watching a show.

Broadcasted reward: The data portion, broadcasted along side the main audio/video content, includes valued information or media, such as music file, newspaper, magazine, weather information, jokes, cartoons, supplementary information to the main show, etc. This data can be delivered at a lower bit rate, throughout the show, to be cached within the hand-held device (Remote Control) or STB or any integrated TV audio/video device. This data is not accessible (i.e. data is encrypted) to the viewer, unless he/she warrant the right to it.

Example: While playing along with the show “Who wants to be a millionaire” (ABC, Disney) via a hand held game device, viewers try to win the top-level prize. Viewers that achieve top level ($500K or $1 M) are entitled for a reward (e.g. free tee-shirt, their name will be broadcasted, enter a sweepstake, access media/music file, etc.). However, if they tune away during commercials, their game resets and they lose the opportunity to win.

Integrating the Remote Control with the Set Top Box: The hand-held devices works in conjunction with a stationary receiver box (Set Top Box). The receiver STB includes memory (volatile or non-volatile, such as DRAM, FLASH, Hard Drive, etc.) Both the hand-held device and the STB can communicate via high-range/low speed Infra Red (IR 60 bytes/sec; 10 meters) and short range/high speed (e.g. IrDA; 10 cm/4 MBps).

The invention thus provides a solution for the implementation of practical application, where both large distances (10 meters) and large amount of data (several megabytes) need to be shared between the receiver and the hand-held device.

In two steps, the user, via low speed/high distance remote control, first selects data (e.g. RC-5) to be saved temporarily (cached) by the receiver. When the user needs to transfer the data to the hand-held device, the user brings the hand-held device to a close proximity with the receiver (STB) and starts a high-speed transfer protocol. All of the cached data transferred from the STB to the hand-held device, then (potentially) gets erased from the receiver.

Example: While viewing a TV commercial, a coupon opportunity is being presented on the audio/video portion of the broadcast. The data portion of the broadcast contain the coupon details, such as the amount, bar-code info, expiration date, product picture, map and directions to the advertisers business, product clarifications and description, etc. If the viewer is interested in the coupon, he/she presses a button on the hand-held device. The receiver executes the IR command from the hand-held device and captures the coupon data into its local memory. Later, the viewer brings the hand-held device near the receiver and initiates a data transfer operation. The coupon data get transferred, in high speed, from the receiver to the hand-held device.

Synchronizing Channel Selection Between Television Receiver and Video Recorder: When Interactive TV data from existing analog TV is extracted by a box connected to the video-out of a VCR or DVD video recorder, then there is a need: a) to ask the viewer to watch TV via the VCR's tuner, and b) to keep the VCR tuner in sync with the TV tuner. The present invention solves how to achieve the TV/VCR (or TV/DVD recorder) tuners synchronization by (b), by means of a special iTV-Universal remote control.

The remote control has these special mechanisms to accomplish this synchronization function:

a. Special iTV button to enable interactivity mode(below)+LED (or other visual) to show that RC is in iTV mode.

b. Internal memory that holds the current TV channel selected+a table of available/un available channels.

c. An explicit channel-up/channel-down buttons that always send full channel tuning signals to the TV (i.e. exact channel number), never “channel-up or down” signal.

d. Buttons to add/delete channels form the channel table [no auto-programming for the remote control]

When the viewer wants to engage in iTV via the remote control, he/she presses the iTV button. At this point the remote control:

a. Sends the VCR an “on” command only (if there the VCR has an explicit ON)

b. Send the VCR a tuning command, switching it to the same channel as the TV

c. Send the TV a tuning command, reinforcing the same channel [this is to validate that the TV, RC, and the VCR are on the same channel]. OR—

d. Sends a tuning command to the TV, switching it to channel 3 or 4, tuning to the VCR's modulator. OR—

e. Sends the VCR a TV/VCR command to allow RF signal pass-through.

f. Puts the RC in iTV mode. All numeric buttons and channel-up/down are used for iTV function, not channel tuning.

g. Pressing the iTV button again reverse everything, including turning off the VCR (to allow preset recording).

Removable Memory and Synchronization with A/V Equipment: In one preferred embodiment, the hand-held system also has a built-in slot for insertion of a removable memory storage device. Into this memory, a large amount of TV related content can be loaded. The memory can be loaded externally or preloaded at the time of manufacture. Special signals from the TV (video) program link the data context inside the memory to the viewed show. Other signals provide time-sensitive synchronization between the data and the video. Interactivity, enhanced programming and commercial value can be realized via and/or on the remote control.

### EXAMPLE 1

Game show material, such as the questions and answers to ABC's “Who Wants to Be a Millionaire” are loaded into the memory device either via a PC and the Internet, or at a kiosk stations or the memory module is sold (given away) with the pre loaded data. The memory holds the content for several show simultaneously. The user inserts the memory module into the above remote control. When the show starts, a special signal is sent to the remote. This signal corresponds to the content on the remote control memory as a “show ID”. In a simplified embodiment of the invention, the user is asked to enter a “show ID” number into the remote to achieve the same function. During the show, more synchronization signals are sent to the remote to facilitate time synchronization; i.e. when a specific question is being asked, the remote can display it; when the answer is given on the TV, then the user is blocked from entering the answer. In a simplified embodiment, a special visible/audible signal is given, asking the viewer to press a button on the remote at a certain moment. An internal clock inside the remote control maintains synchronization with the show from the moment on, based on time along; e.g. the remote control knows that 17:23 minute into show #216, question #12 is presented for 11:09 seconds.

### EXAMPLE 2

The memory module is preloaded with numerous inactive e-coupons. When a commercial is shown, a unique number appears on the TV (“AD ID”). The view can enter the number to activate coupon. If necessary, date/time (and channel) stamp can verify that the user activated the coupon as a direct response to ad viewing. [In this example, the invention device is not a “remote control” but a “shopping companion” or “eTV—saver”].

Advantages: Very low bit rate can be used to link TV and video to rich data content. The remote control has only to sync to the TV content but does not need to receive the data/content itself from the broadcaster. This allows very simple and inexpensive implementation, even on existing analog TV broadcasting equipment and receivers. A PC and or a phone line do not need to be accessible within the TV proximity. Prepackaged iTV content business can be realized.

Interactive Channel Redirection: In another aspect, the invention provides a method to deploy show-reminders which act to deliver a visual and or aural message to viewers to entice them to switch to a competing channels programming. Interactive show reminders are delivered to a suitably equipped Television, set-top box or personal video recorder or VCR, and annunciate themselves based on the timing of broadcast television programming in addition to other parameters.

The purpose of the show reminders is to entice a viewer to view a particular television program at a particular time. Show reminders can take many forms including but not limited to small static or animated icons overlaid on a television video screen including those with associated sound segments, which further encourage the viewer to acknowledge these offers. Show reminders can be constructed using a number of standard or proprietary technologies such as HTML derivatives and or Flash.

After annunciating itself, if the viewer agrees to view the offered program, the user can activate a special button on a RC which acts to then re-tune the tuner of the television, set-top box or Personal video recorder or VCR to the channel number associated with the show-reminder.

It is anticipated that the user can designate an existing button on the remote control for the purpose of acknowledging the show reminder. Once the consumer acknowledges the Show-reminder, a record of the acknowledgement can be stored in memory for future auditing purposes.

It is also anticipated that Show-reminders can be deployed to redirect a viewer to view another concurrent broadcast on another cable or broadcast channel as well as direct them to a live TV cache of a program already in progress such that they may view it from the beginning, or to previously recorded material as may be found on the hard disk of a PVR.

Delivery of show reminders is anticipated to in several ways: as a data-cast within a DTV transmission, or as data in the VBI or HBI of an analog NTSC transmission or impressed within an Analog NTSC TV transmission, or in cellular or satellite transmission or as an FM sub-carrier of a commercial AM or FM radio transmission or as data from an internet connection via DSL, cable modem, or POTS dial-up either directly to the television, set-top box or Personal video recorder or VCR or to a special adjunct receiver specially designed to receive and overlay these show-reminders, or first received via a home person computer, which then relay the show-reminder data to the television, set-top box or Personal video recorder or VCR via a home network connection including but not limited to Ethernet, HomePNA, powerline or from a wireless connection within the home such as via bluetooth or 802.11b or other proprietary method or system.

The auditing function of the show-reminder system acts to report acknowledged show-reminders to a third party. In addition to acknowledged show-reminders, activities of the view can be audited and reported to the third party such as the dwell time of the viewer after the show reminder was switched and from what channel they were transferred from. Third parties are able to infer which TV commercials may have been viewed etc. It is anticipated that remuneration to the viewer upon acknowledgement of the show reminders will encourage its acceptance.

The show-reminder is comprised of at least one or more of the following data types: graphic data, sound data, and animation data. In addition, all show reminders contain channel target data used to determine which channel to tune to once the show-reminder has been acknowledged.

A plurality of show reminders may be presented sequentially and or simultaneously and present a view with a number of choices for viewing. It is anticipated that show reminders can be presented with a reward system which allows allows for direct compensation to be made to viewers for them acknowledging a particular show-reminder. (Reverse Auction).

In the case of integrated system where the television signal tuner and video overlay circuit are integrated show reminder data can directly act to control the tuning of the television receiver. This is the case in such devices such as television, set-top box, Personal video recorder or VCR.

In the case of adjunct device, the base-band video of a VCR or other TV tuning device with a base band output would be used as the primary TV signal which will have show reminders overlaid. In this case a separate IR blaster would be deployed to control the tuner by generating suitable IR codes to change channels.

The show reminder circuit that consists of a video memory, a communications method, a video overlay circuit, sound memory, sound D/A converter an IR receiver, IR transmitter and a connection to the host device TV tuning circuit. In the case of an adjunct device, a separate IR decoding means is required.

### Additional Details of the Preferred Embodiments

Memory: Any suitable memory can be used, including FLASH memory such as Secure Digital (SD), Smart Media, Compact Flash, Memory Stick, etc. Disk-based storage such as MicroDrive, PocketZip; battery powered RAM; other comparable non-volatile storage memory.

Sync signal: Synchronization between the hand-held device and the television receiver, VCR, video recorder, set top box and/or other consumer electronic devices may be by one or more of the following methods: Audible; Visible or invisible encoded into the video; Encoded in NTSC (PAL, SECAM) VBI or any other invisible portion of the signal; Encapsulated into the DTV (MPEG data packets); Manual entry by end user, prompted by audio/video signal; Other communication system capable of conveying the signals described herein.

Signal delivery for A/V device to remote control: Physical signal delivery between the A/V device and the hand-held device may be by any suitable means, including: Wire; RF signal; Infrared; Optically; Audio (wired, over the air).

Devices with which the invention may be used: It will be apparent that the invention may be used with a wide variety of devices including, but not limited to the following: TV set (analog, DTV); Set Top Box (STB); DVD player/recorder; game console; VHS recorder; PVR/DVR; Other consumer electronic product; any combination of the above.

The present invention also relates generally to electronic coupons. More particularly, the invention relates to certain improvements in electronic coupons that provide automatic, scheduled, perishable and variable redemption features, and to electronic holders for such coupons.

The preferred embodiment employs a coupon holder in the form of a handheld device has an embedded display, CPU, software memory (volatile, nonvolatile, and removable) and at least one-way communication. The device stores coupon information in a secure (encrypted) way. Coupon information is delivered to the device via wired, wireless, or physical (FLASH memory card) communication. Possible sources of the coupon data include the Internet, TV (data broadcasting), direct dial-up connection, and mailing.

The coupons can have variable redemption values that are mediated by metadata included in the electronic data files defining the coupon. In one embodiment, coupon metadata includes: coupon amount, product description, categorization, expiration date, images, retailer address, and a map. Additionally, a coupon's metadata may include a schedule for varying redemption values. The device automatically adjusts the coupon value based on the predetermined schedule.

According to another aspect of the invention, the portable coupon holder device has display and coupon management software that allows the user to view coupon information, but it does not allow the user to view the redemption information (typically bar-code) until it is time to make a payment.

While browsing their coupons, the user can mark or unmark coupons for later redemption. At the point of sale (cash register), the user activates the coupons' redemption display. The device automatically starts to display coupon redemption information (typically bar code), one at a time. Each “redeemed” coupon displayed is marked for deletion within a set time (e.g. 15 minutes). After the time delay elapses, all of the coupons displayed are deleted from the device, however, a log of the redeemed coupons can be saved. The delay is designed to allow for the correction of errors, such as matching the right product to the coupon.

The redemption process described is preferably bar-code display (optical redemption) compatible with existing point-of-sale equipment. Other methods can be wired or wireless (infrared, RF, etc.) communications.

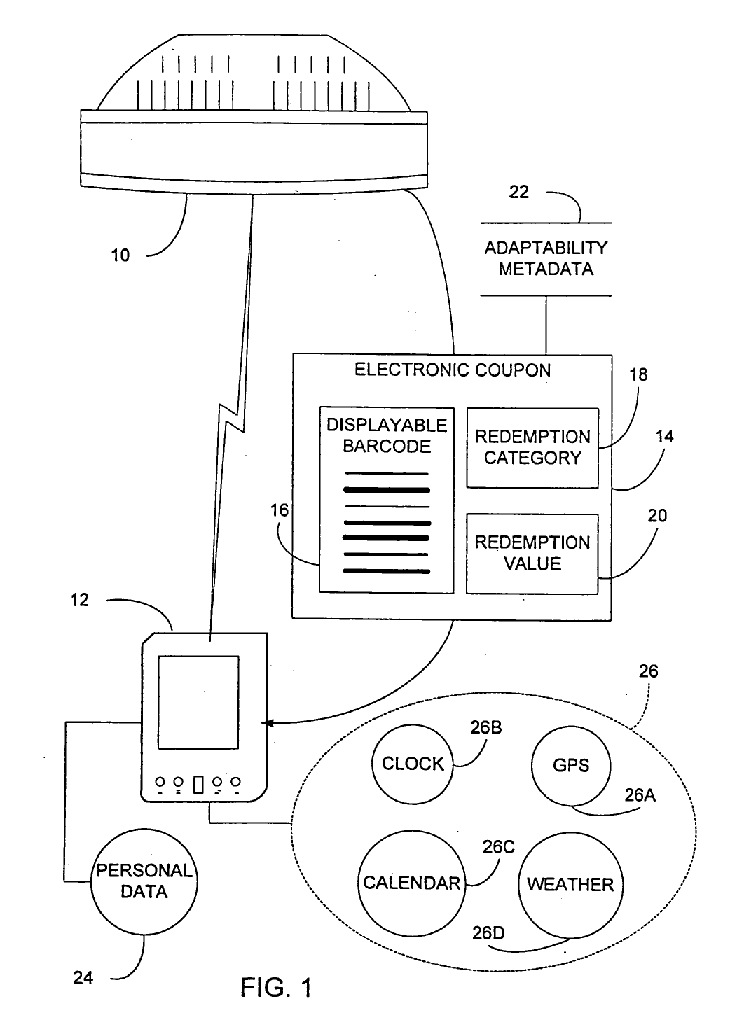

While there are many possible embodiments and forms that the invention can take, the following will present examples of several useful embodiments. For example, while watching TV commercials, coupons for ice-cream, breakfast cereal, and laundry detergent (new—with ultra-bleach) are transmitted to the handheld device. By taking the handheld device to the supermarket, the shopper can locate the ice-cream (under frozen), the cereal, and the detergent (old—no bleach). The shopper marks, in the device, every item he or she picks up. At the cash register, the shopper activates the coupons' redemption display, while placing the device's display on the barcode reader surface. The cash register will reject the detergent coupon because it didn't scan a matching product. The shopper has 15 minutes to switch the detergent with the newer one. By the time the shopper leaves the supermarket, all of the redeemed coupons are automatically invalid, but a shopping log (for future reference) is created. As another example, an electronic coupon for a pair of jeans has an initial value of $20. After one week, its worth is reduced to $15, and it's reduced an additional $5 per week each week thereafter. This fading coupon can add incentive for buyers not to procrastinate with their buying decision. As a further example, an electronic coupon for a meal at a pizza chain has a value of $10 during the week, $5 on the weekend (day), and $0 on weekend nights. The handheld device will maintain and display the variable value of the coupon. The present invention is more fully described below with reference to FIGS. 1-3.

Referring to FIG. 1, an interactive television 10 is capable of communicating with a remote control 12 modeled on a Personal Digital Assistant (PDA). An adaptive electronic coupon 14 according to the present invention is thereby communicated from interactive television 10 to remote control 12. The adaptive electronic coupon 14 has a displayable bar code 16, a redemption category 18 specifying a particular product and/or place of redemption, and a redemption value 20 specifying a benefit to be conferred on a user relative to the redemption category 18. It further has adaptability metadata 22 defining conditions for changing the redemption category 18 and/or redemption value 20 based on a user's personal data 24 and/or redemption environment 26.

A user may thus transport the electronic coupon to a time and place of redemption, and redemption characteristics (redemption category and/or redemption value) can change. For example, if redemption category is for an amusement park and the weather conditions are too cold for swimming, the redemption category can change from being good for a discount on admission to the entire amusement park (including an adjacent waterpark) to being good on admission to a portion of the amusement park that excludes the waterpark. Also, a coincident increase in the redemption value (discount) can also be applied. Similarly, a forecast for intermittent rain on a day of redemption can increase the redemption value to the amusement park. Further, the redemption value on a coupon for pizza may be increased during the week and decreased on weekends, and/or decreased during foul weather conditions (when delivery orders tend to increase). Further, a redemption category and/or redemption value for a coupon at a gift shop may change from the Christmas shopping season to the Valentine's Day shopping season. Also, during Valentines' Day shopping season, the redemption category may change for a user's personal data, such that a male user may have a coupon good for a discount on flowers, while a female user may have a coupon good for a discount on a chocolate Teddy Bear. Personal data can be obtained from a data store on the remote control or, if the remote control can access the Internet, over the Internet. Coupons can become valid on days significant for the user, such as a birthday, and/or for products of a type preferred by the user. The displayable bar code can also change to reflect the redemption category and/or redemption value.

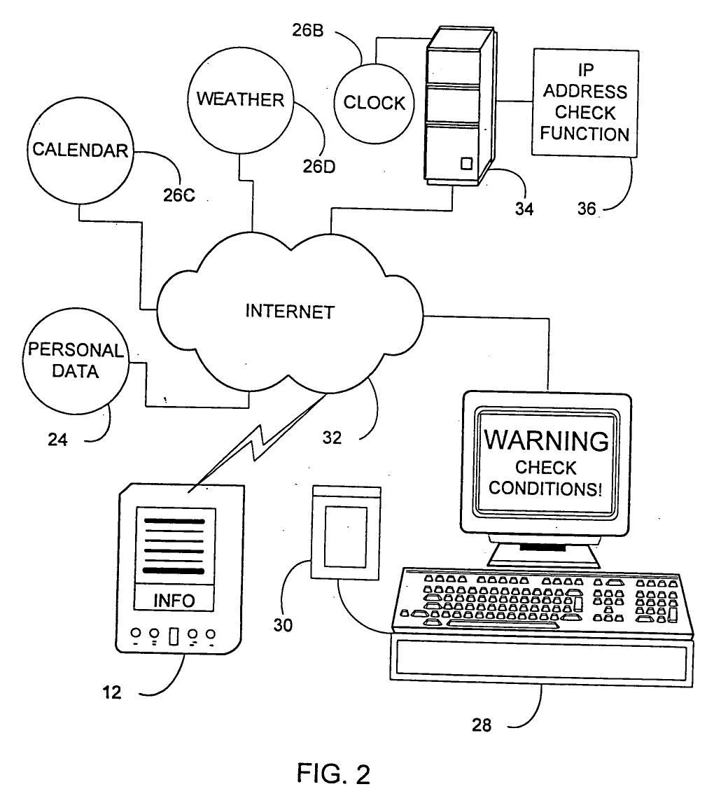

Referring to FIG. 2, the user can, using the remote control 12 transport the electronic coupon to a time and place of redemption, such that the displayable bar code can be scanned at a cash register 28 using a typical bar code scanner 30. The appropriate changes can be affected in the coupon using data contained in the remote control 12, obtained over the Internet 32 by the remote control 12, or obtained by a communication link between the remote control 12 and the cash register 28. Verification procedures may require the remote control to obtain the information 26B-D for determining some or all of the conditions over the Internet and/or by synchronizing with a verification server 34. The verification server 34 can also determine the location of the remote control 12 and/or the cash register 28 using Internet Protocol (IP) address checking function 36. The verification measures can also display the barcode coincident with the necessary conditions for honoring the coupon, and/or the cashier can be prompted to verify that the conditions have been met. The cashier can potentially access the Internet and even the verification server to determine the validity of the coupon, and alternatively determine the actual conditions by a priori knowledge. As another alternative, the verification procedure can require the remote control 12 and cash register 28 to communicate with one another so that the conditions can be verified. In such an alternative implementation, it is also possible to forego the bar code display in favor of a redemption code transmittal.

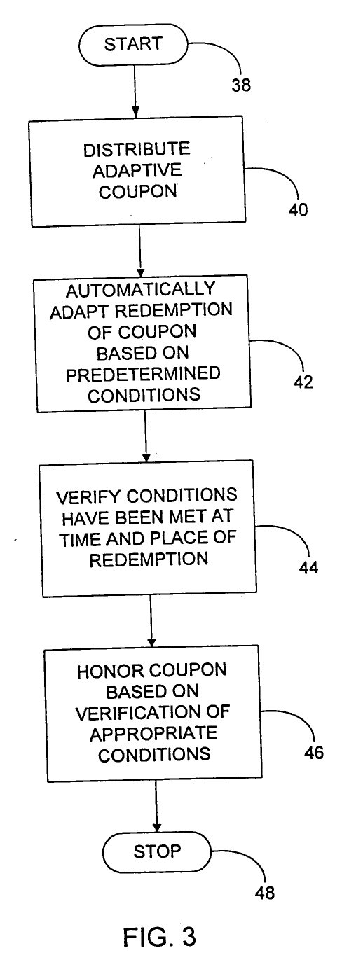

Referring to FIG. 3, a method of conditionally redeeming an adaptive electronic coupon according to the present invention begins at 38 and proceeds to step 40, wherein the coupon is distributed electronically. Interactive television is one example of electronic coupon distribution, but other types of distribution are also supported, including the Internet and digital devices present at a sales location. Redemption characteristics of the coupon are automatically adapted at step 42 based on predetermined conditions. Metadata defines the conditions in one embodiment, but other ways of defining the conditions are also supported. At step 44, a verification occurs at the time and place of redemption that the predetermined conditions have been met. Thence, the coupon is honored at step 46 based on the verification of the appropriate conditions, and the method ends at 48.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for conditionally redeeming an electronic coupon, comprising:
a distribution module distributing an adaptive electronic coupon to a user;
electronic coupon metadata automatically changing redemption characteristics of the coupon post distribution based on predetermined conditions relating to personal data of the user and a redemption environment;
a redemption system honoring the adaptive electronic coupon at a time and place of redemption based on the predetermined conditions relating to the personal data of the user and the redemption environment.

2. The system of claim 1, comprising a verification system verifying that the predetermined conditions have been met at the time and place of redemption.

3. The system of claim 1, wherein the redemption characteristics correspond to a redemption category and a redemption value.

4. The system of claim 1, wherein the predetermined conditions relate to a time of redemption.

5. The system of claim 1, wherein the predetermined conditions relate to a place of redemption.

6. The system of claim 1, wherein the predetermined conditions relate to a weather condition at a time and place of redemption.

7. A method of conditionally redeeming an adaptive electronic coupon, comprising:
distributing an adaptive electronic coupon to a user, wherein the coupon has metadata automatically changing redemption characteristics of the coupon post distribution based on predetermined conditions relating to personal data of the user and a redemption environment;
automatically changing redemption characteristics of the coupon based on predetermined conditions relating to personal data of the user and a redemption environment;
honoring the adaptive electronic coupon at a time and place of redemption based on the predetermined conditions relating to the personal data of the user and the redemption environment.

8. The method of claim 7, wherein said distributing the adaptive electronic coupon to the user corresponds to distributing the adaptive electronic coupon to the user, wherein the adaptive electronic coupon has a redemption category, a redemption value, and adaptability metadata defining dependency of at least one of the redemption category and the redemption category on the predetermined conditions.

9. The method of claim 8, wherein said automatically changing redemption characteristics of the coupon based on predetermined conditions relating to personal data of the user and a redemption environment corresponds to changing at least one of the redemption category and the redemption value according to the predetermined conditions.

10. The method of claim 7 comprising verifying that the predetermined conditions have been met at the time and place of redemption.

11. The method of claim 7, wherein the predetermined conditions relate to a time of redemption.

12. The method of claim 7, wherein the predetermined conditions relate to a place of redemption.

13. The method of claim 7, wherein the predetermined conditions relate to a weather condition at a time and place of redemption.

14. A hand-held device comprising:
a communication system for controlling at least one consumer electronic product corresponding to a broadcast media delivery device;
a memory storing a user reward corresponding to an electronic coupon having redemption terms, wherein the coupon has metadata automatically changing the redemption terms of the coupon post distribution based on predetermined conditions relating to personal data of the user and a redemption environment;
a processing system having user interaction capability and an embedded procedure adapted to mediate the user reward.

15. The device of claim 14 wherein said processing system includes embedded procedure to discourage channel changing.

16. The device of claim 14 wherein said embedded procedure includes mediating a viewer reward according to variable redemption terms relating to personal data of a user and a place of redemption.

17. The device of claim 14 wherein said embedded procedure includes procedure to synchronize channel changes between plural consumer electronic products.

18. The device of claim 17 wherein said plural products include a television receiver and a video recorder.

19. The device of claim 14 wherein said embedded procedure implements a channel redirection operation.

20. The device of claim 14 wherein said embedded procedure implements a show reminder operation.

21. The device of claim 14 wherein said memory is removable.

22. The device of claim 14 further comprising system to synchronize said memory with a second memory associated with a consumer electronic product.

23. The device of claim 14 further comprising system to synchronize said memory with a second memory associated with a set top box.

24. A portable electronic coupon viewer comprising,
a hand-held device having electronic memory associated therewith;
a data structure defined within said memory for storing electronic coupon data, including coupon metadata that embeds information regarding the commercial terms of said coupon, wherein the coupon metadata automatically changes redemption characteristics of the coupon post distribution based on predetermined conditions relating to personal data of the user and a redemption environment; and
an active display embedded in the handheld device and adapted to visually render an electronic coupon according to the electronic coupon data and variable expiration terms associated therewith.

25. The portable viewer of claim 24 wherein said metadata includes at least one datum for mediating redemption expiration terms.

26. The portable viewer of claim 24 wherein said metadata includes at least one datum for mediating variable redemption terms relating to personal data of a user and a place of redemption.

27. An electronic coupon, comprising:
a computer memory having a data structure to represent said electronic coupon;
said data structure including metadata that embeds information regarding the commercial terms of said coupon including variable redemption terms, wherein the metadata automatically changing redemption characteristics of the coupon post distribution based on predetermined conditions relating to personal data of the user and a redemption environment.

28. The electronic coupon of claim 27 wherein said metadata includes at least one datum for mediating variable redemption terms relating to personal data of a user and a place of redemption.

29. The electronic coupon of claim 27 wherein said metadata includes at least one datum for mediating expiration terms.
